(19) United States
(12) Patent Application Publication
(10) Pub. No.: US 2010/0082739 A1
(43) Pub. Date: Apr. 1, 2010

(54) METHOD FOR SUPPORTING MEDIA INDEPENDENT HANDOVER (MIH) SERVICES

(75) Inventors: Miguel Martin, Leimen (DE); Albert Vidal, Heidelberg (DE); Claudia Villalonga, Heidelberg (DE)

Correspondence Address: YOUNG & THOMPSON, 209 Madison Street, Suite 500, Alexandria, VA, 22314, US

(73) Assignee: NEC EUROPE LTD., Heidelberg (DE)

(21) Appl. No.: 12/532,324

(22) PCT Filed: Mar. 19, 2007
(86) PCT No.: PCT/EP2007/002414

§ 371 Date: Dec. 15, 2009

(51) Int. Cl. G06F 17/30; G06F 15/16

(52) U.S. Cl. 709/203; 707/609; 707/705; 707/E17.005

(57) ABSTRACT

A method for supporting media independent handover (MIH) services, preferably according to the IEEE 802.21 standard, wherein communication nodes (1) attach to a network via a Point of Attachment (PoA) which has access to an information server (IS) via appropriate network entities, wherein the information server (IS) operates an information database, and wherein information from the information database, upon respective requests from the communication nodes (1), is forwarded from the information server (IS) to the requesting communication nodes (1), is characterized in that the communication nodes (1) send messages to the information server (IS), wherein the content of the messages is analysed by the information server (IS) and employed to incorporate new information in its information database and/or to update information already stored in its information database.

The present invention relates to a method for supporting media independent handover (MIH) services, preferably according to the IEEE 802.21 standard, wherein communication nodes attach to a network via a Point of Attachment which has access to an information server via appropriate network entities, wherein the information server operates an information database, and wherein information from the information database, upon respective requests from the communication nodes, is forwarded from the information server to the requesting communication nodes.

In recent years several types of wireless communication systems have been developed. For example, wireless local area networks (WLAN) are widely spread nowadays, cellular networks, such as Universal Mobile Telecommunication Systems (UMTS), have gained paramount importance, and, most recently, WiMAX (defined as Worldwide Interoperability for Microwave Access) has been developed as a standard-based technology enabling the delivery of last mile wireless broad band access. Each of these systems provides different types of services and specific applications.

For seamless handover between different types of networks, the IEEE 802.21 MIH (Media Independent Handover) specification has been developed. The scope of the IEEE 802.21 standard is to develop a specification that provides link layer intelligence and other related network information to upper layers to optimise handovers between heterogeneous media. In this context, “media” refers to the method or mode of accessing a telecommunication system (e.g. cable, radio, satellite, etc.), as opposed to sensory aspects of communication (e.g. audio, video, etc.).

The standard aims at providing means to improve handovers across heterogeneous networks by sharing information, events and commands between MIH peers which, most generically, will be referred to in the following as communication nodes (mobile terminals, network entities, etc.). The Information Service, for sharing information between communication nodes, is one of the key concepts of the MIH architecture. This service assumes a centralized information database which resides in the operator's core network and which, in the context of the 802.21 standard, is operated by an Information Server IS. The data stored in this database provide information about the neighbouring networks of a communication node. Consequently, a communication node may request information from the database such as Network Type, Operator Identifier, Service Provider Identifier, Access Network Identifier, Roaming Partners, Cost, Network Standards, Security in Network, QoS in the Network, etc. Every time a communication node needs an update of this kind of information it may send a respective query to the information database.

When MIH peers or communication nodes cannot communicate directly with each other, they have to communicate through an intermediary MIH entity which will forward the messages acting as a proxy. This procedure is defined as multi-hop or proxy-operation. For cases in which an information requesting communication node is not directly connected to its Information Server it may first send a request message to its Point of Attachment. A Point of Attachment may be a node to which the communication node is attached, and which has access to the Information Server, either directly or indirectly via appropriate network entities that forward the request to the correspondent Information Server, acting as an intermediary or proxy.

The procedure of requesting and providing information between a communication node and a centralized information database as described above proves to be disadvantageous in that it is not guaranteed that the information stored in the information database is valid when it is requested by a communication node. This is because within the 802.21 standard there is no update mechanism specified for the Information Server IS. In principle, it is solely the operator of the IS or the entity responsible of managing the IS which has to take care of the richness and freshness of information stored in the Information Server's database.

It is therefore an object of the present invention to improve and further develop a method of the initially described type for supporting media independent handover services in such a way that by employing mechanisms that are readily to implement a performance improvement in terms of richness, freshness and completeness of information stored in the information server's database is achieved.

In accordance with the invention, the aforementioned object is accomplished by a method comprising the features of claim 1. According to this claim such a method is characterized in that the communication nodes send messages to the information server, wherein the content of the messages is analysed by the information server and employed to incorporate new information in its information database and/or to update information already stored in its information database.

According to the invention it has first been recognised that a mechanism for updating the information stored in the information server's database that is exclusively carried out by the operator of the information server is critical with respect to the freshness of the stored information. Furthermore, it has been recognised that the timeliness as well as the richness of information stored in the information server's database can be significantly improved by allowing the communication nodes to upload fresh information. The communication nodes updating the information in the information server may be individual users, preferably customers of the operator of the information server, or other network operators. By allowing users to conduct the updates of the information server by themselves, the system is very dynamic and loyal to the current state of the network with the information in the information server being always fresh and thorough due to periodically updates by users in the field.

Moreover, by including communication nodes in the update procedure of the information server according to the invention the richness of information stored at the information server is enhanced, as the information server can be notified about more networks (which are not known to the operator of the information server, but only to certain communication nodes). For example, networks of secondary network operators can be registered in the information server by sending an appropriate message to the information server. According to the standard this was not possible unless an agreement already existed between the secondary and the primary, i.e. the information server operator.

In a preferred embodiment the information server decides about the acceptance of a message received from a communication node according to configurable criteria. Only in cases in which all criteria are fulfilled, the information server employs the content of the message in order to conduct an update operation. Otherwise the message may be discarded. For example, the configurable criteria may include the kind of authorization of the communication node, i.e. the information server may be configured in such a way that only messages from authorized communication nodes are further processed. The authorization may be due to the fact that the respective communication node is registered as a customer of the operator which is responsible of managing the information server.

In addition to authorization issues the information server may conduct further plausibility checks. For example, the information server may use information forwarded to it by a communication node for an update only in such cases in which it receives a configurable number of messages from different communication nodes containing the same readings within a configurable time period. In reverse, this means that an isolated message will be condemned as untrustworthy. For example, if a communication node reports on a network not yet registered in the information server, the information server will attend to the registration of this network only if the existence of this network is confirmed by other communication nodes from the same geographical region. This mechanism strongly supports the detection of intentionally faked information from certain users.

As already indicated above, the messages sent by the communication nodes to the information server may contain information regarding available networks in the vicinity of the communication node. The messages may include information regarding the properties and/or capabilities of the networks, congestion and status details for each network as well as general information elements like network type, operator identifier, service provider identifier, etc. Furthermore, information regarding all services and their characteristics offered by a network may be reported to the information server by the communication nodes.

With respect to a particular effective update, the information server may be operated in a proactive manner, i.e. the information server may send request messages to communication nodes requesting information in order to update its information database. By adding such a request message in MIH the information server may be enabled to trigger a discovery and report on certain communication nodes. A proactive operation mode of the information server as described above proves to be especially advantageous for geographical regions for which the information server disposes only of little or no information. In such cases, the information server can send request messages exactly to communication nodes located in these regions in order to update its insufficient or stale data related to the respective region. Thus, the information server can be updated only when needed. In this context it can be taken into account that in WLAN environments, in general, changes occur more frequently than for example in UMTS/GSM environments.

In a preferred embodiment the request messages sent from the information server to communication nodes may be configured in the same format as specified for MIH request messages in the context of the IEEE 802.21 specification. Thus, the request messages are easy to implement with no changes of the standard being required. In addition, the response messages from the communication nodes to the information server may also be configured in the same format as specified for MIH response messages in the context of the IEEE 802.21 specification.

In a further preferred embodiment the information requested by the information server is forwarded to the information server by those communication nodes which dispose of the requested information. With regard to a high reliability, the information server may average the readings of all responding nodes before employing the responses for an information update in its information database. Such a measure helps to avoid that responses by single communication nodes which contain faked information substantially affect the update process.

In the context of a concrete application, coverage maps may be generated on the basis of the information gathered and stored in the information server's information database. The coverage map may be a real time coverage map illustrating the geographical distribution of the signal strength and other characteristics for each of the discovered networks. Such a map, which has a minimum cost for the operator, can be used for improving the resource distribution, and in particular, it would be possible to reveal gaps in the network coverage, to eliminate redundancies, to trace competitors, etc. From a user point of view, however, it proves to be especially advantageous, when the coverage maps are used to guide the communication nodes to locations that are beneficial from a network point of view. In a potential embodiment, the communication node/user might be prompted to walk a small distance in a certain direction in order to receive coverage from a more beneficial network or to find a special service he is looking for. In this regard, by the expression “beneficial” issues such as the connection prize, bandwidth, latency, etc. may be understood.

In another embodiment access credentials and/or information on invisible networks and/or services may be provided to the communication nodes. Such an application takes into account that nowadays certain networks are hidden, as it is the case of hidden ESSIDs (Extended Service Set IDdentifier) in WiFi. In these cases communication nodes usually need to receive information about the existence of these networks through some other channel, usually via physical media or via a direct message from someone else. By using MIH as described above the trusted relationship with the operator could be used to provide access to hidden networks. In other words, information about hidden networks may be uploaded to the information server with the aid of the communication nodes, and MIH may be used as an access control technology for e.g. hotspots to automatically convey said information to authorized parties.

It is noted that the methods as described herein are not exclusive of MIH as defined in the IEEE 802.21 specification. It becomes clear to someone skilled in the art that the method as described above applies to any existing or upcoming protocol with similar mechanisms or functionalities.

There are several ways how to design and further develop the teaching of the present invention in an advantageous way. To this end it is to be referred to the patent claims subordinate to patent claim 1 on the one hand and to the following explanation of preferred embodiments of the invention by way of example, illustrated by the figure on the other hand. In connection with the explanation of the preferred embodiments of the invention by the aid of the figure, generally preferred embodiments and further developments of the teaching will we explained.

In the drawings:

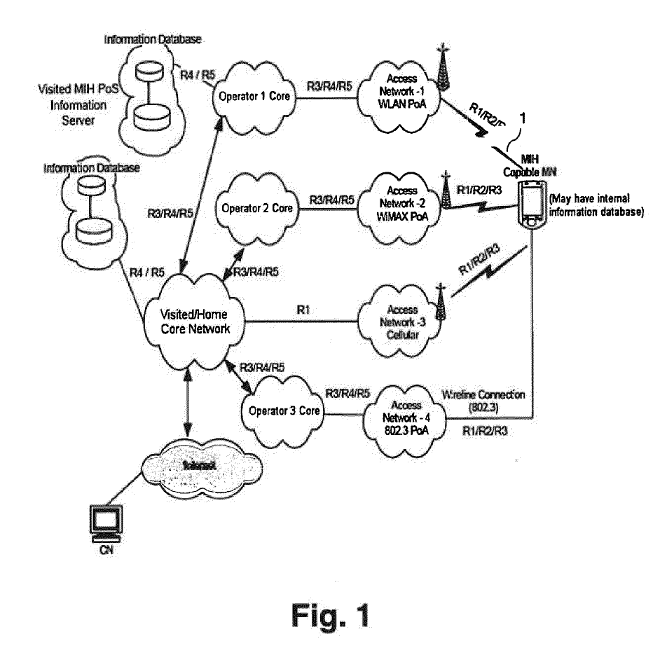

FIG. 1 is a schematic view of a typical network architecture illustrating the MIH communication model in general,

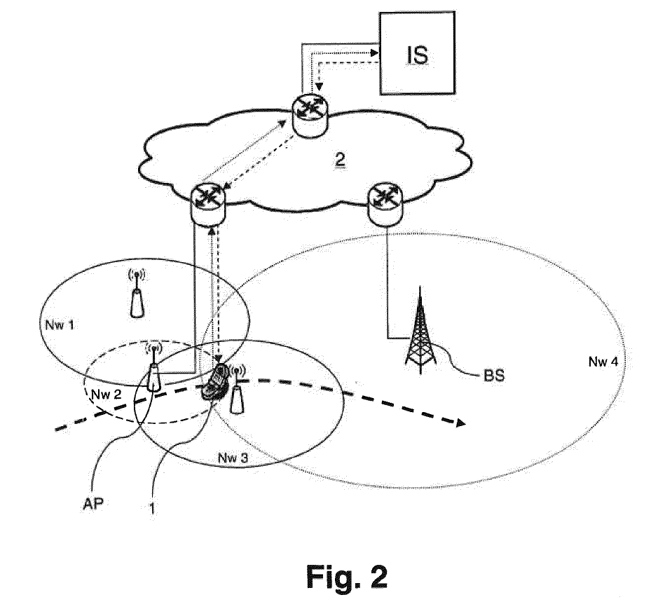

FIG. 2 is a schematic view of a network architecture illustrating a mode of operation of MIH services according to the 802.21 standard,

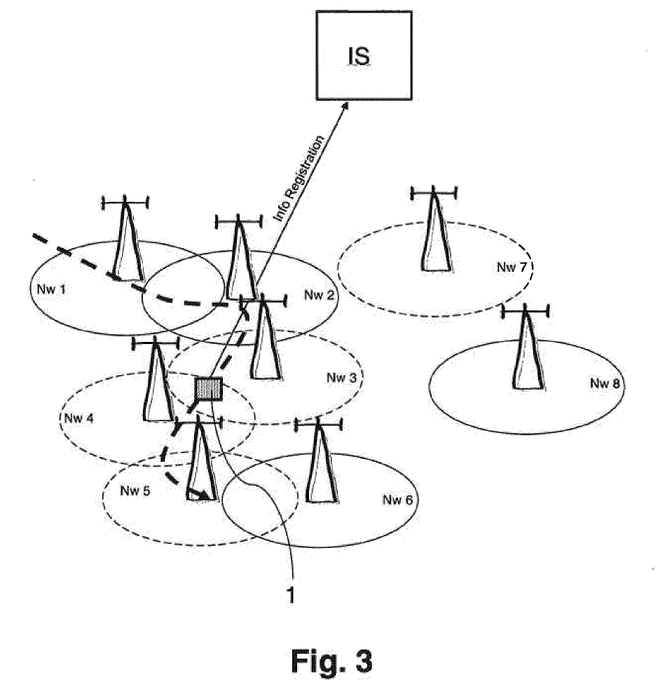

FIG. 3 is a schematic view illustrating an Information Server update process according to a first embodiment of the invention,

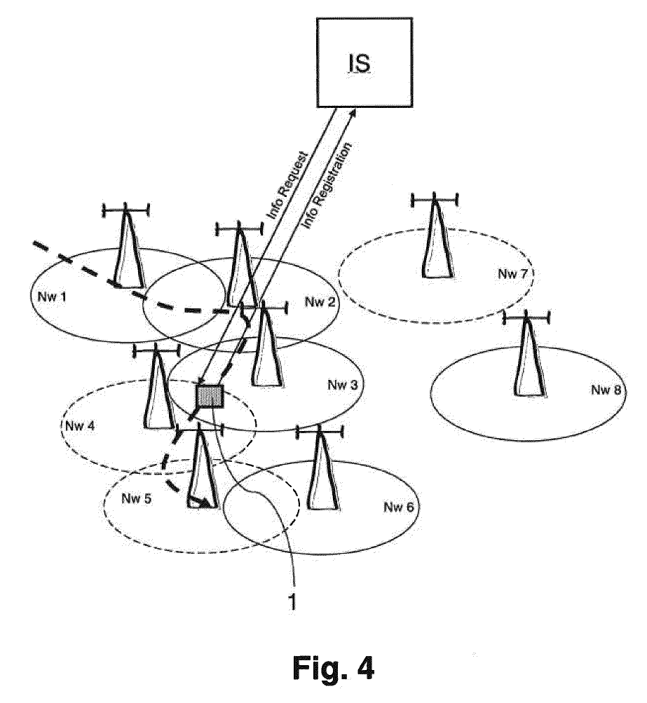

FIG. 4 is a schematic view illustrating an Information Server update process according to a second embodiment of the invention, and

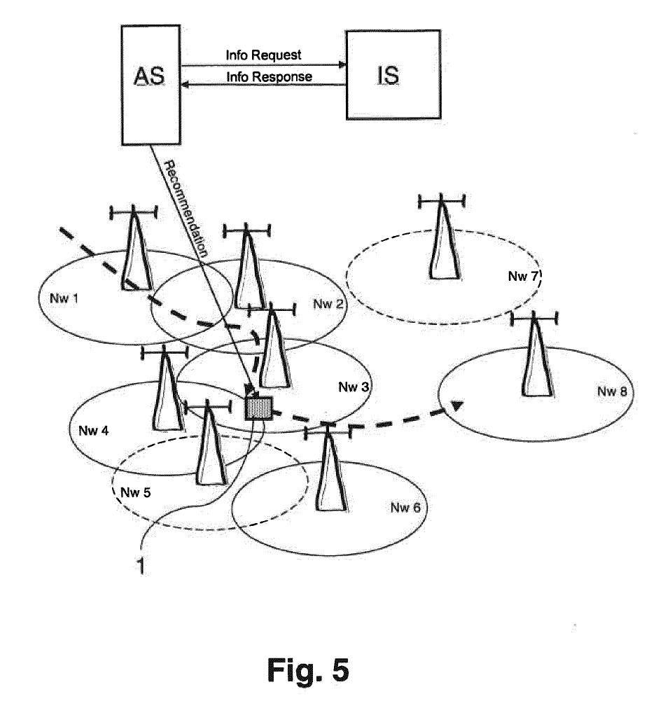

FIG. 5 is a schematic view illustrating an example of an application scenario of the method according to the invention.

FIG. 1 illustrates a network model including MIH services in which the method according to the invention is applicable. More particularly, FIG. 1 gives an illustration of the MIH communication reference points in a typical network architecture. The model includes an MIH capable communication node 1 which supports multiple wired and/or wireless access technology options.

The model shown in FIG. 1 includes four exemplary access networks 1-4. The access networks 1, 2 and 4 are connected to a core network (Operator 1-3 Core, respectively), whereas access network 3 is a cellular network which is coupled to a core network that is labelled as Visited/Home Core Network. In this context the terms visited and home indicate the provisioning service provider or enterprise. Any of the illustrated networks can be either a Visited or Home Network depending on the relation of the operator to the provisioner of the communication node 1. The Operator 1-3 Core each might represent a service provider or corporate intranet provider.

Network providers offer MIH services in their access networks (Access Networks 1-4) to facilitate handover into their networks. Each access technology either advertises its MIH capability or responds to MIH service discovery. Each service provider for the access network allows access to one or more MIH Points of Service (PoS). These PoS may provide some or all of the MIH services as determined during MIH capabilities discovery. The location or node of an MIH PoS is not fixed by the standard. The PoS location may vary based on operator deployment scenario and the technology-specific MIH architecture.

An MIH PoS may reside next to or be co-located with the point of attachment (PoA) in the access network (in this regard Access Networks 1, 2, and 4 are typical). Alternatively the PoS may reside deeper inside the access or core network (in this regard Access Network 3 is typical). As shown in FIG. 1, the MIH entity in the communication node 1 communicates with MIH network entities either by R1, R2 or R3 over any access network. According to the 802.21 the communication reference points R1-R5 shown in FIG. 1 are defined as follows:

R1 refers to MIHF (Media Independent Handover Function is a functional implementation of MIH services as defined in the 802.21 specification) procedures between the MIHF on the communication node 1 and the MIH PoS on the Network Entity of its serving PoA.

R2 refers to MIHF procedures between the MIHF on the communication node 1 and the MIH PoS on the Network Entity of a candidate PoA. Candidate PoAs are PoAs that the communication node 1 is aware of but not currently attached to; it becomes the target PoA if a handover eventually occurs. R1 and R2 may encompass communication interfaces over both L2 and L3 and above.

R3 refers to MIHF procedures between the MIHF on the communication node 1 and the MIH PoS on a non-PoA Network Entity. R3 may encompass communication interfaces over L3 and above and possibly L2 transport protocol like Ethernet bridging, MPLS, etc.

R4 refers to MIHF procedures between an MIH PoS in a Network Entity and an MIH non-PoS instance in another Network Entity. R5 refers to MIHF procedures between two MIH PoS instances in distinct Network Entities. R4 and R5 may encompass communication interfaces over L3 and above. MIHF content passed over R1-R5 may be related to MIIS (Media Independent Information Service), MIES (Media Independent Event Service), or MICS (Media Independent Command Service).

The interaction of visited and home network could be either for control and management purposes or for data transport purposes. It is also possible that due to roaming or SLA agreements, the home network may allow the communication node 1 to access the public Internet directly through a visited network. As illustrated, two MIH network entities may communicate with each other via R4 or R5 reference connections. The MIH capable PoA may also communicate with other MIH network entities via R3 and R4 reference points. The MIH capable communication node 1 could have a MIH communication with other PoA in the candidate access networks via R2 reference points to obtain information services about the candidate network.

With regard to the MIH Information Service (MIIS) the providers offer access to their information server located in a MIH PoS node (upper far left). The operator provides the MIIS to communication nodes so they can obtain pertinent information including but not limited to new roaming lists, costs, provider identification information, provider services, priorities and any other information that would enable to select and utilize services. It is possible for the communication node 1 to be pre-provisioned with MIIS data by its provider. Also possible is for the communication node 1 to obtain MIH information services from any access network of its provider. MIIS could also be available from another overlapping or nearby network, using that network's MIIS point of service. A provisioner's network (depicted here as coupled with Access Network 3) may utilize R3 and R4 interfaces to access other MIH entities like the provisioner's or visited network's MIH information server.

With regard to the MIH Command Service (MICS) the Information Database (far left, mid-way down) depicts a command service PoS. The communication node's 1 MIHF typically communicates with this server using a layer three transport.

Based on the general architecture according to the 802.21 standard as described with respect to FIG. 1, FIG. 2 is an illustration of an application scenario of a MIH service according to the 802.21 specification. In the upper part of FIG. 2 an operator's core network 2 is shown which operates an MIH Information Server (IS). The Information Server IS includes an information database in which information regarding networks known to the operator's core network 2 are stored.

In the lower part of FIG. 2 altogether four networks Nw 1-Nw 4 are shown. Network Nw 2 is a WLAN which is connected to the operator's core network 2 via its access point AP. The coverage area of network Nw 2 is indicated by the dashed line surrounding. Furthermore, a WiMax (Nw 4) indicated by the dotted line surrounding is connected via its base station BS to the operator's core network 2. The two additional networks (Nw 1 and Nw 3) indicated by the solid line surroundings are operated by provider X and provider Y, respectively, and are not known to the operator's core network 2.

In FIG. 2 the path of movement of a communication node 1 is indicated by the dashed directory. In the concrete scenario shown the communication node 1 has moved to the border of the coverage area of the WLAN Nw 2 resulting in a weakening signal strength of the WLAN Access Point AP. The communication node 1 sends a MIH_Information.Request message to the operator's core network 2 (as indicated by the dotted line arrows) requesting information regarding a better network connection. The request message is forwarded from the operator's core network 2 to the MIH Information Server IS. The Information Server IS checks whether the requested information is already included in its information database. If the information database contains the requested information and if the information possesses validity regarding its expiration period as well as regarding the location from which the request messages originates, the Information Server IS forwards the requested information to the operator's core network 2 and from there the information is forwarded to the requesting communication node 1 (as indicated by the dashed line arrows).

In the special case shown in FIG. 2, the MIH_Information.Response message will contain the information that a good connectivity with high data rate can be obtained by registration to Nw 4 (WiMax). Consequently, the communication node 1 will perform a seamless handover and registers with the WiMax base station BS. On the other hand, the communication node 1 is located very close to the access point of network Nw 3 operated by provider X so that this network might offer the most beneficial network connection for the communication node 1. However, as described above, network Nw 3 is not known to the operator's core network 2 and, consequently, there are no information regarding this network included in the Information Server IS of operator's core network 2. As a consequence, the communication node 1 is not aware of network Nw 3 and performs handover to network Nw 4 which, as the case may be, provides inferior operation parameters compared to network Nw 3.

FIG. 3 illustrates, schematically, an information server IS update process according to a first embodiment of the invention. For the purpose of a concise illustration, in the upper part of FIG. 3 only the information server IS is shown, although it is to be understood that the information server IS is connected to an operator's core network as it is shown in FIG. 2. The networks with a solid line surrounding, labelled as Nw 1, Nw 2, Nw 6, and Nw 8, indicate networks that are already registered to the information server IS (and, naturally, to the operator's core network which operates the information server IS and which is not shown in FIG. 3 as indicated above). The networks with a dashed line surrounding, labelled as networks Nw 3, Nw 4, Nw 5, and Nw 7, are not registered to the information server IS.

As in FIG. 2, the dashed line trajectory again indicates a geographical path of movement of a communication node/user 1. In the snap-shot presented in FIG. 3 the communication node 1 is located or moves in a geographical region where there are no networks that are known to the information server IS. Consequently, the user's terminal 1 starts a scanning process in order to find neighbouring networks to which a connection would be possible. As a result, the user's terminal 1 discovers the networks Nw 3 and Nw 4. After the discovery of these networks the communication node 1 sends a message (that is referred to as Info Registration in FIG. 3) to the information server IS according to the invention reporting on the new network it has discovered. In fact, this message is preferably the MIH_Get_Information.Response as defined in the 802.21 specification. The content of the message is analysed by the information server IS and employed to incorporate new and fresh information regarding the networks Nw 3 and Nw 4 into its information database.

FIG. 4 illustrates, schematically, an information server IS update process according to a second embodiment of the invention. FIG. 4 shows the same network topography as shown in FIGS. 3 and also the scenario is quite similar to FIG. 3. However, in contrast to the scenario shown in FIG. 3, a triggered information server IS update process is illustrated in FIG. 4. The user 1 is connected to network Nw 3 and the information server IS has few information about the networks at the area in which the user 1 is located. The information server IS guesses that there are some networks that are not registered. Consequently, the information server IS triggers the user 1 to scan and to send an update. Concretely, the process may be conducted as follows:

1. The information server IS requests the information about the networks in the vicinity of the user/communication node 1. To this end it sends a MIH request to the communication node 1 as indicated by the Info Request arrow in FIG. 4.

2. The communication node 1, upon receipt of the triggering message from the information server IS, performs a scan and thereby discovers network Nw 4.

3. The communication node 1 sends a MIH response message (as indicated by the Info Registration arrow in FIG. 4) to the information server IS informing that network Nw 4 is available.

4. The information server IS carries out an acceptance check and, if it considers that the information is reliable (maybe due to the fact, that other nodes also report the same information), the information server IS includes network Nw 4 in its information database.

FIG. 5 illustrates, schematically, an application scenario based on an embodiment of the method according to the invention. FIG. 5 shows the same network topography as shown in FIGS. 3 and 4 with the networks Nw 3 and Nw 4 now being registered to the information server IS due to the messages sent from the communication node 1 to the information server IS as described in connection with FIGS. 3 and 4. Only networks Nw 5 and Nw 7 remain as not being registered to the information server IS.

In FIG. 5, an application server AS is connected to the information server IS. On the basis of the information stored in the information server's database, which are exchange between the AS and the IS via appropriate request and response messages, the application server AS generates a coverage map. The coverage map illustrates the geographical distribution of the signal strength for each of the networks registered to the information server IS. On the basis of the coverage map the application server AS forwards a recommendation message to the communication node 1 proposing an alternative network for the user 1. For example, the application server AS notifies the user 1 that network Nw 8 is available if he walks 200 meters right. Additionally, the application server AS provides information regarding the signal strength, the QoS, the costs, the services, etc. of network Nw 8. Since the user 1 considers network Nw 8 more beneficial for his current purposes he moves into the direction as given by the application server AS what is indicated by the dashed line trajectory.

It is to be noted that lists of information elements (IEs) as stored in the information database of information servers IS according to the IEEE 802.21 specification do not take into account at all services and their characteristics. However, this could be another important factor for the handover decision. For example, in FIG. 5 the user 1 might be perceiving a very good signal strength from the access point of network Nw 3 which offers beamer projection services, but what he is really interested in is a printing service. This service is offered, for example, by network Nw 8 which is further located. Consequently, the signal strength of its access point received by the communication node 1 is lower. In such a scenario, according to the IEs defined in the current 802.21 specification, user's mobile device 1 would definitely choose Nw 3 and never Nw 8. However, as the application server AS also provides information regarding the services offered by the networks that are registered to the information server IS, the user 1 is free to choose which network he wants to use.

Many modifications and other embodiments of the invention set forth herein will come to mind the one skilled in the art to which the invention pertains having the benefit of the teachings presented in the foregoing description and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

1. A method for supporting media independent handover (MIH) services, preferably according to the IEEE 802.21 standard, wherein communication nodes (1) attach to a network via a Point of Attachment (PoA) which has access to an information server (IS) via appropriate network entities, wherein the information server (IS) operates an information database, and wherein information from the information database, upon respective requests from the communication nodes (1), is forwarded from the information server (IS) to the requesting communication nodes (1),
characterized in that the communication nodes (1) send messages to the information server (IS), wherein the content of the messages is analysed by the information server (IS) and employed to incorporate new information in its information database and/or to update information already stored in its information database.

2. The method according to claim 1, wherein the information server (IS) decides about the acceptance of a message received from a communication node (1) according to configurable criteria.

3. The method according to claim 1, wherein the decision about the acceptance of a message received from a communication node (1) is based on the kind of authorization of the communication node (1).

4. The method according to claim 1, wherein the content of a message is employed by the information server (IS) only in the case that the information server (IS) receives a configurable number of messages from different communication nodes (1) containing the same readings within a configurable time period.

5. The method according to claim 1, wherein the messages sent by the communication nodes (1) to the information server (IS) contain information regarding available networks in the vicinity of the communication nodes (1) including information regarding the properties, capabilities and/or services of said networks.

6. The method according to claim 1, wherein the information server (IS) sends request messages to communication nodes (1) requesting information in order to update its information database.

7. The method according to claim 6, wherein the request messages are sent to communication nodes (1) located in a geographical area from which information is needed.

8. The method according to claim 6, wherein the request messages sent from the information server (IS) to communication nodes (1) are configured in the same format as specified for MIH request messages in the context of the IEEE 802.21 specification.

9. The method according to claim 1, wherein the messages sent from the communication nodes (1) to the information server (IS) are configured in the same format as specified for MIH response messages in the context of the IEEE 802.21 specification.

10. The method according to claim 1, wherein the requested information is forwarded to the requesting information server (IS) by those communication nodes (1) which dispose of the requested information.

11. The method according to claim 1, wherein the information server (IS) averages the readings of all responding communication nodes (1) before incorporating and/or updating information in its information database.

12. The method according to claim 1, wherein coverage maps are generated on the basis of the information stored in the information server's (IS) information database.

13. The method according to claim 12, wherein the coverage maps are used to guide the communication nodes (1) to locations that are beneficial from a network point of view.

14. The method according to claim 1, wherein access credentials and/or information on invisible networks and/or services are provided to the communication nodes (1).

15. The method according to claim 2, wherein the decision about the acceptance of a message received from a communication node (1) is based on the kind of authorization of the communication node (1).

16. The method according to claim 7, wherein the request messages sent from the information server (IS) to communication nodes (1) are configured in the same format as specified for MIH request messages in the context of the IEEE 802.21 specification.
